(19) United States
(12) Patent Application Publication
(10) Pub. No.: US 2009/0025586 A1
(43) Pub. Date: Jan. 29, 2009

(54) WEB-FED ROTARY PRINTING PRESS

(75) Inventor: Klaus LIEPERT, Westendorf (DE)

Correspondence Address: CROWELL & MORING LLP;INTELLECTUAL PROPERTY GROUP, P.O. BOX 14300, WASHINGTON, DC, 20044-4300, US

(73) Assignee: manroland AG, Offenbach/Main (DE)

(21) Appl. No.: 12/180,351

(22) Filed: Jul. 25, 2008

(30) Foreign Application Priority Data
Jul. 28, 2007 (DE) 10 2007 035 432.2

(51) Int. Cl. B41F 13/56

(52) U.S. Cl. 101/227

(57) ABSTRACT

A web-fed rotary printing press is disclosed. The printing press having several printing units and having a folding unit, and a turner bar nest and folding superstructure positioned between the printing units and the folding unit, in which at least one printing substrate web can be separated into partial webs and/or the or each printing substrate web or the or each partial web can be conveyed via turner bars and/or guide rollers to at least one former. At least one guide roller is respectively positioned along the transport path of the or each printing substrate web and/or the or each partial web through the turner bar nest and the folder superstructure, whose two ends are each assigned an adjusting unit, via which the respective end of the respective guide roller can be displaced linearly in and/or opposite from the running direction of the respective printing substrate web or partial web.

This application claims the priority of German Patent Document No. 10 2007 035 432.2, filed Jul. 28, 2007, the disclosure of which is expressly incorporated by reference herein.

### BACKGROUND AND SUMMARY OF THE INVENTION

The invention relates to a web-fed rotary printing press.

A web-fed rotary printing press has several printing units for printing at least one printing substrate web. In the case of newspaper printing presses, normally several printing units in the form of printing towers are positioned in a vertically stacked manner. Viewed in the transport direction of the or each printing substrate web downstream from the printing units, the web-fed rotary printing press has a folding unit, wherein copies are separated from the or each printing substrate web by cross-cutting in the region of the folding unit. In addition, the folding unit is used to form at least one cross fold and/or at least one longitudinal fold on the separated copies. A so-called turner bar nest and folder superstructure is positioned between the printing units and the folding unit of the web-fed rotary printing press, wherein in the region of the turner bar nest and folder superstructure at least one printing substrate web can be separated into partial webs by longitudinal cutting. Alternatively or in addition to this, the or each printing substrate web or the or each partial web can be conveyed via turner bars and/or guide rollers to at least one former of the turner bar nest and folder superstructure.

Web-fed rotary printing presses known from practice have both a device for cut-off compensator control as well as a device for web edge control, wherein, according to practice, these devices are designed as separate units, which are positioned independent of one another along the transport path of the or each printing substrate web or the or each partial web preferably in the region of the turner bar nest and folder superstructure. This requires relatively a lot of construction space.

Starting herefrom, the present invention is based on the objective of creating a novel web-fed rotary printing press. According to the invention, at least one guide roller is respectively positioned along the transport path of the or each printing substrate web and/or the or each partial web through the turner bar nest and the folder superstructure, whose two ends are each assigned an adjusting unit, via which the respective end of the respective guider roller can be displaced linearly in and/or opposite from the running direction of the respective printing substrate web or partial web, namely in such a way that either both ends of the respective guide roller can be displaced uniformly to influence the cut-off compensator or both ends of the respective guide roller can be displaced non-uniformly to influence the edge position of the respective printing substrate web or partial web.

In the case of the inventive printing press, control of the cut-off compensator as well as control of the web edge position of the or each printing substrate web or the or each partial web is realized jointly by respectively at least one guide roller. The cut-off compensator control as well the web edge control are therefore in the case of the inventive printing press not realized by separate units, but in fact combined into one unit. This allows construction space to be saved.

Each adjusting unit is preferably embodied as an electromotive actuator, in particular as an electromotive linear drive.

Preferred developments of the invention are disclosed in the following description. Exemplary embodiments of the invention are explained in greater detail on the basis of the drawings.

### BRIEF DESCRIPTION OF THE DRAWINGS

FIG. 1 is a schematic section of an exemplary embodiment of an inventive web-fed rotary printing press; and

FIG. 2 is a detail of the embodiment according to FIG. 1.

### DETAILED DESCRIPTION OF THE DRAWINGS

The present invention relates to a web-fed rotary printing press, which has several printing units for printing at least one printing substrate web, and a folding unit. Copies can be separated from the or each printing substrate web by cross-cutting in the region of the folding unit. In addition, at least one longitudinal fold and/or at least one cross fold can be formed in the region of the folding unit. A so-called turner bar nest and folder superstructure is positioned between the printing units and the folding unit.

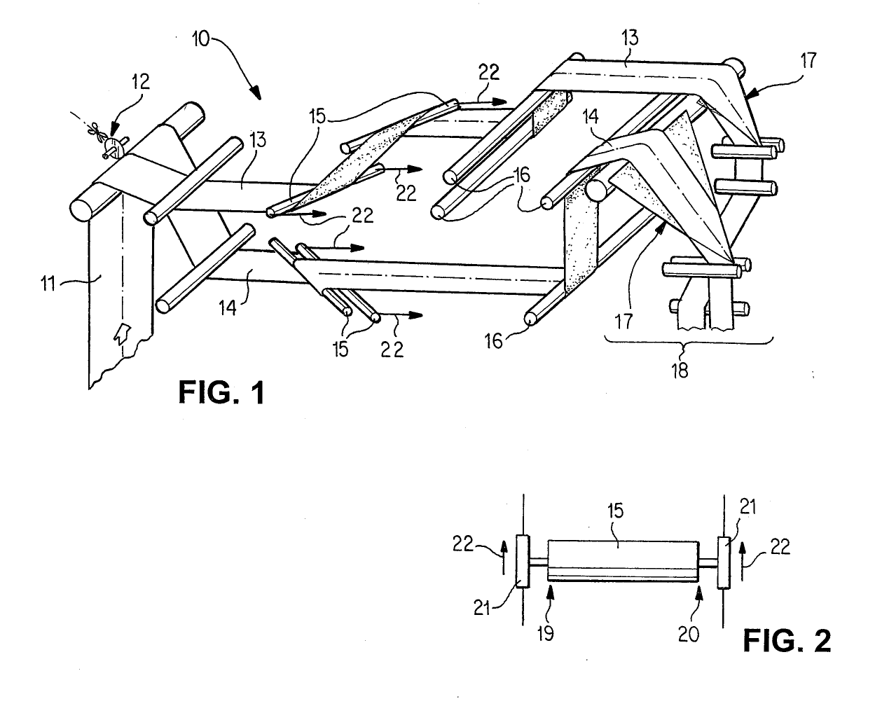

FIG. 1 shows a section of a web-fed rotary printing press in the region of a turner bar nest 10, wherein, in the region of the turner bar nest 10 in FIG. 1, a printed printing substrate web 11 is being separated into two partial webs 13, 14 by longitudinal cutting with the aid of a cutting device 12. The partial webs 13, 14 can be conveyed via guide rollers 15, 16 to a former 17 of a folder superstructure 18 arranged after the turner bar nest 10. In the region of the former 17 longitudinal folds are formed on the partial webs 13, 14, wherein as viewed in the transport direction of the partial webs 13, 14, downstream from the former 17 copies are being cut by cross-cutting the partial webs 13, 14 and thus the printing substrate web 11.

In terms of the present invention, at least one guider roller 15 is respectively positioned along the transport path of the two partial webs 13, 14, whose two ends 19, 20 are each assigned an adjusting unit 21 (see FIG. 2), via which the respective end 19, 20 of the respective guide roller 15 can be displaced linearly in or opposite from the running direction of the respective partial web 13, 14. The linear displaceability of the ends 19, 20 of the guide rollers 15 is visualized in FIGS. 1 and 2 by arrows 22.

According to the invention, the ends 19, 20 on each guide roller 15 can be displaced via the corresponding adjusting units 21 either uniformly to influence or control the cut-off compensator or non-uniformly to influence or control the edge position of the respective partial web 13, 14. Every guide roller 15 embodied in the above manner is thus used, on the one hand, for web edge control and, on the other hand, for cut-off compensator control. The adjusting units 21 assigned to each guide roller 15 can be activated either uniformly or non-uniformly in order to linearly displace the corresponding ends 19, 20 of the respective corresponding guide roller 15 either uniformly or non-uniformly in the running direction or opposite from the running direction of the respective partial web 13, 14.

Each adjusting unit 21 is preferably embodied as an electromotive actuator, in particular as an electromotive linear drive. This permits a displacement of the guide rollers 15 with a high dynamic so that simultaneous dynamic control of the cut-off compensator and lateral edge position of the respective partial web or printing substrate web is possible.

FIG. 1 shows a possible embodiment of a tuner bar nest 10, to which at least one adjusting unit 15 is assigned for each partial web 13, 14. The invention is not limited to this concrete application case. In fact, the invention can also be used in the case of web-fed rotary printing presses that have other turner bar superstructures and folder superstructures.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A web-fed rotary printing press, having several printing units for printing at least one printing substrate web, and having a folding unit in order to separate copies from the or each printing substrate web by cross-cutting and to form at least one longitudinal fold and/or at least one cross fold, and having a turner bar nest and folding superstructure positioned between the printing units and the folding unit, in which at least one printing substrate web is separable into partial webs by longitudinal cutting and/or in which the or each printing substrate web or the or each partial web is conveyable via turner bars and/or guide rollers to at least one former, wherein at least one guide roller is respectively positioned along a transport path of the or each printing substrate web and/or the or each partial web through the turner bar nest and the folder superstructure, whose two ends are each assigned an adjusting unit, via which a respective end of the respective guider roller is displaceable linearly in and/or opposite from a running direction of the respective printing substrate web or partial web, namely in such a way that either both ends of the respective guide roller are displaceable uniformly to influence a cut-off compensator or both ends of the respective guide roller are displaceable non-uniformly to influence an edge position of the respective printing substrate web or partial web.

2. The web-fed rotary printing press according to claim 1, wherein each adjusting unit is embodied as an electromotive actuator.

3. The web-fed rotary printing press according to claim 2, wherein each adjusting unit is embodied as an electromotive linear drive.

4. The web-fed rotary printing press according to claim 1, wherein each adjusting unit is assigned to the turner bar nest.

5. A web-fed rotary printing press, comprising:
a printing unit for printing a printing substrate web;
a folding unit; and
a turner bar nest and a folding superstructure positioned between the printing unit and the folding unit, wherein the printing substrate web is conveyable via turner bars and/or guide rollers;
wherein at least one guide roller is positioned along a transport path of the printing substrate web through the turner bar nest and the folder superstructure, wherein two ends of the at least one guide roller are each assigned an adjusting unit, via which a respective end of the at least one guider roller is displaceable linearly in and/or opposite from a running direction of the printing substrate web.

6. The web-fed rotary printing press according to claim 5, wherein the two ends of the at least one guide roller are displaceable uniformly.

7. The web-fed rotary printing press according to claim 6, wherein the two ends of the at least one guide roller influence a cut-off compensator

8. The web-fed rotary printing press according to claim 5, wherein the two ends of the at least one guide roller are displaceable non-uniformly.

9. The web-fed rotary printing press according to claim 8, wherein the two ends of the at least one guide roller influence an edge position of the printing substrate web.
